(19) United States
(12) Patent Application Publication
(10) Pub. No.: US 2008/0311504 A1
(43) Pub. Date: Dec. 18, 2008

(54) METHOD OF MANUFACTURING TONER AND TONER

(76) Inventors: Mizuki HATTORI, Numazu-shi (JP); Shinzo Higuchi, Numazu-shi (JP); Takahiro Kadota, Numazu-shi (JP); Daisuke Misawa, Numazu-shi (JP); Hiroshi Takahashi, Numazu-shi (JP); Toshihiko Usami, Numazu-shi (JP); Masashi Miyakawa, Susono-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/124,742

(22) Filed: May 21, 2008

(30) Foreign Application Priority Data
May 31, 2007 (JP) 2007-144821

(51) Int. Cl. G03G 9/00

(52) U.S. Cl. 430/113; 430/137.14

(57) ABSTRACT

A method of manufacturing toner including adding an oil phase comprising an organic solvent in which a binder resin, a coloring agent and a releasing agent are dissolved or dispersed and an aqueous phase to an emulsification device equipped with a stirrer, continuously dispersing or emulsifying the oil phase and the aqueous phase in the emulsification device equipped with a stirrer to form a liquid dispersion or emulsion comprising oil phase particles, transporting the liquid dispersion or emulsion to a tank, removing the organic solvent from the liquid dispersion or emulsion followed by drying to form mother toner particles, wherein the releasing agent has been preliminarily prepared to have a dispersion diameter of from 0.15 to 0.7 μm before the releasing agent is contained in the oil phase, a circumferential speed of the stirrer is from 15 to 25 m/s, and a volume particle diameter (DV′) of the oil phase particles at an exit of the emulsification device to the tank and a volume average particle diameter (Dv) of the oil phase particles in the tank satisfy the following relationships:

3.0≦DV′≦6.0 Relationship 1

4.0≦Dv≦7.5 Relationship 2

1.0≦Dv−Dv′≦3.0 Relationship 3.

### BACKGROUND OF THE INVENTION

1. Field of the Invention

The present invention relates to a method of manufacturing toner and a toner manufactured by the method.

2. Discussion of the Background

In an electrophotographic image forming apparatus, images are formed on the surface of an image bearing member (photoreceptor, photoconductor) by: a charging process in which charges are provided to the surface of an image bearing member by discharging; an irradiation process in which the surface of the charged image bearing member is irradiated to form a latent electrostatic image thereon; a development process in which a toner having a polarity opposite to that of the latent electrostatic image on the surface of the image bearing member is provided thereto. Subsequent to a transfer process in which the toner image formed on the surface of the image bearing member is transferred to a recording medium such as paper directly or by way of an intermediate transfer body, the transferred toner image on the recording medium is fixed by a fixing process in which the toner image is fixed upon application of heat and pressure.

In the fixing process, a fixing member formed of a pair of rollers or belts having a heater inside sandwiches the recording member and fixes the toner on the recording medium by heating and melting the toner while applying pressure thereto. When the heating temperature is too high, the toner excessively melts, which causes a hot offset problem in which the melted toner adheres to the fixing member. When the heating temperature is too low, the toner does not sufficiently melt, resulting in insufficient fixing. In light of energy saving and size reduction of an image forming apparatus, a toner having a good combination of hot offset resistance and low temperature fixability is demanded.

Especially in the case of a full color photocopier and a full color printer, toner is desired to have a good low melt viscosity in terms of gloss and color mixture and thus a polyester based toner binder having a sharp melt property has been used. Since such a toner tends to cause the hot offset problem, it is typical that silicon oil is applied to a fixing member for a full color apparatus.

However, to apply silicone oil to a fixing member, an oil tank and an oil applying device are necessary, which leads to size increase and a complex structure of an image forming apparatus. In addition, application of silicone oil causes deterioration of a fixing member and requires maintenance at a regular interval. Furthermore, it is inevitable that oil attaches to a recording medium such as photocopying paper and film for transparent sheets. Especially, a problem occurs to film for transparent sheets that attached oil causes color tone deterioration.

As a result, a method in which a releasing agent, i.e., wax, is added to toner is typically used to prevent attachment of melted toner without oil application to a fixing member. However, the releasing effect of wax greatly depends on the dispersion status thereof in a binder resin.

For example, Japanese patent No. (hereinafter referred to as JP) 2663016 describes a toner manufactured by suspension-polymerizing a material having a polar group and a polymerizable monomer including a releasing agent in an aqueous phase. The thus manufactured toner can contain a wax having a low melting point which is not usable for a toner manufactured by a pulverization method and has good granularity, a sharp particle size distribution and stable chargeability such as a good charge control property. JP 2663016 also specifies that, unlike a polar component, a non-polar component such as wax is not present on or near the surface of a toner particle and takes a capsule-like structure with polar components existing on the surface. However, the distribution of wax inside a toner particle is not analyzed and thus the detail is unknown.

JP 3225889 describes a toner having a scale-like wax in an amount of from 0.1 to 40% by weight which exposes to the surface of the toner in an amount of from 1 to 10% by weight based on the compositions exposing thereto. The ratio of the wax to the toner surface is measured and regulated by electron spectroscopy for chemical analysis (ESCA). However, according to the analysis based on ESCA, the information obtained is limited to a depth of around 0.1 μm from the surface of a toner particle. Thus, the information about the dispersion status of wax which exists inside a toner particle and is expected to effectively perform releasing in the fixing process is unknown, which causes a problem that suitable conditions are not provided.

Unexamined published Japanese patent application No. (hereinafter referred to as JOP) 2002-6541 describes a toner containing a wax in such a manner that wax locally exists near the surface of the toner but there is no description about a specific dispersion status of the wax existing on or near the toner surface.

JOPs 2004-109485, 2004-246345 and 2004-318043 describe the dispersion status of a releasing agent (wax) near the surface of toner in detail. These specify the amount of wax existing near the toner surface and the control methods therefor such as usage of wax particle diameter, wax addition amount and dispersion agent. However, when these methods are used, there is possibility of problems such that stability relating to emulsification of a polymerized toner, filming property and agglomeration property depending on the addition amount of wax, fixing property due to the usage of dispersion agent, etc., are adversely affected.

In addition, JOPs 2005-301261 and 2007-71965 describe a technology in detail to prevent fusion attachment of toner by forming a structure called core-shell structure in which a core layer is covered with a shell layer. In these JOPs, the resins and their converted molecular weights in the core layer and the shell layer and the amount of wax existing near the toner surface are specified but the dispersion status of the wax is unknown.

To solve these problems, the wax particle diameter, the addition amount of wax, and the control method of wax existing near the surface of toner by using a dispersion agent are keys. Especially, a process technology by which wax existing near the surface of toner can be controlled irrespective of the addition amount of wax is demanded.

### SUMMARY OF THE INVENTION

Because of these reasons, the present inventors recognize that a need exists for a method of manufacturing toner which has a good combination of low temperature fixability, cold offset resistance, hot offset resistance and anti-filming by a manufacturing technology controlling the amount of a releasing agent existing near the surface of toner irrespective of the addition amount of the releasing agent.

Accordingly, an object of the present invention is to provide a method of manufacturing toner which has a good combination of low temperature fixability, cold offset resistance, hot offset resistance and anti-filming by a manufacturing technology controlling the amount of a releasing agent existing near the surface of toner irrespective of the addition amount of the releasing agent and the toner obtained thereby.

Briefly this object and other objects of the present invention as hereinafter described will become more readily apparent and can be attained, either individually or in combination thereof, by a method of manufacturing toner including: adding an oil phase including an organic solvent in which a binder resin, a coloring agent and a releasing agent are dissolved or dispersed and an aqueous phase to an emulsification device equipped with a stirrer; continuously dispersing or emulsifying the oil phase and the aqueous phase in the emulsification device equipped with a stirrer to form a liquid dispersion or emulsion including oil phase particles; transporting the liquid dispersion or emulsion to a tank; removing the organic solvent from the liquid dispersion or emulsion followed by drying to form mother toner particles. In the method, the releasing agent has been preliminarily prepared to have a dispersion diameter of from 0.15 to 0.7 μm before the releasing agent is contained in the oil phase, a circumferential speed of the stirrer is from 15 to 25 m/s, and a volume particle diameter. (DV′) of the oil phase particles at an exit of the emulsification device to the tank and a volume average particle diameter (Dv) of the oil phase particles in the tank satisfy the following relationships:

3.0≦DV′≧6.0 Relationship 1

4.0≦Dv≦7.5 Relationship 2

1.0≦Dv−Dv′≦3.0 Relationship 3.

It is preferred that, in the method described above, the binder resin has a characteristic peak at least at a wave number of 828 cm⁻¹ and the releasing agent has a wave number of 2,850 cm⁻¹ in an infrared spectrum obtained by a Fourier transform infrared-attenuated total reflectance (FTIR-ATR) method and the surface amount (Ws) of the releasing agent located on or near the surface of the toner and the total amount (Wt) of the releasing agent in the toner satisfy the following relationships:

0.01≦Ws/Wt≦0.05 Relationship 4

0.05≦Ws≦0.20 Relationship 5

4≦Wt≦10 Relationship 6,

in the relationships, the total amount (Wt) represents a weight conversion value converted from an endothermic absorption amount of the releasing agent in the toner obtained by a differential scanning thermometer (DSC) and the surface amount (Ws) is a value obtained from an intensity ratio (P2,850/P828) of the peak value (2,850 cm⁻¹) of the releasing agent to the peak value (828 cm⁻¹) of the binder resin.

It is still further preferred that, in the method described above, the releasing agent is selected from the group consisting of carnauba wax which is subject to a treatment of eliminating free aliphatic acid therefrom, rice wax, montan wax, ester wax and a combination thereof.

It is still further preferred that, in the method described above, the weight ratio of the oil phase to the aqueous phase is from 0.25 to 1.5.

It is still further preferred that, in the method described above, the binder resin includes a polyester resin.

It is still further preferred that, in the method described above, the oil phase further includes a compound having an active hydrogen group and a polymer having a portion reactive with the compound, and further including granulating the oil phase particles by reacting the compound with the polymer.

It is still further preferred that, in the method described above, the ratio (Dv/Dn) of the volume average particle diameter (Dv) of the oil phase particles in the tank to the number average particle diameter (Dn) thereof is not greater than 1.20.

As another aspect of the present invention, a toner is provided which is manufactured by adding an oil phase including an organic solvent in which a binder resin, a coloring agent and a releasing agent are dissolved or dispersed and an aqueous phase to an emulsification device equipped with a stirrer; continuously dispersing or emulsifying the oil phase and the aqueous phase in the emulsification device equipped with a stirrer to form a liquid dispersion or emulsion including oil phase particles; transporting the liquid dispersion or emulsion to a tank; removing the organic solvent from the liquid dispersion or emulsion followed by drying to form mother toner particles. In the method, the releasing agent has been preliminarily prepared to have a dispersion diameter of from 0.15 to 0.7 μm before the releasing agent is contained in the oil phase, a circumferential speed of the stirrer is from 15 to 25 m/s, and a volume particle diameter (DV′) of the oil phase particles at an exit of the emulsification device to the tank and a volume average particle diameter (Dv) of the oil phase particles in the tank satisfy the following relationships:

3.0≦DV′≦6.0 Relationship 1

4.0≦Dv≦7.5 Relationship 2

1.0≦Dv−Dv′≦3.0 Relationship 3.

It is preferred that, in the toner described above, the binder resin has a characteristic peak at least at a wave number of 828 cm⁻¹ and the releasing agent has a wave number of 2,850 cm⁻¹ in an infrared spectrum obtained by a Fourier transform infrared-attenuated total reflectance (FTIR-ATR) method and the surface amount (Ws) of the releasing agent located on or near the surface of the toner and the total amount (Wt) of the releasing agent in the toner satisfy the following relationships:

0.01≦Ws/Wt≦0.05 Relationship 4

0.05≦Ws≦0.20 Relationship 5

4≦Wt≦10 Relationship 6,

in the relationships, the total amount (Wt) represents a weight conversion value converted from an endothermic absorption amount of the releasing agent in the toner obtained by a differential scanning thermometer (DSC) and the surface amount (Ws) is a value obtained from an intensity ratio (P2,850/P828) of the peak value (2,850 cm⁻¹) of the releasing agent to the peak value (828 cm⁻¹) of the binder resin.

### BRIEF DESCRIPTION OF THE DRAWING

Various other objects, features and attendant advantages of the present invention will be more fully appreciated as the same becomes better understood from the detailed description when considered in connection with the accompanying drawing in which like reference characters designate like corresponding parts throughout and wherein:

FIGURE is a diagram illustrating an example of dispersion and/or emulsification by an emulsification device equipped with a stirrer and a tank for storing liquid dispersion and/or emulsification sent therefrom in the method of manufacturing toner of the present invention.

### DETAILED DESCRIPTION OF THE INVENTION

The present invention will be described below in detail with reference to several embodiments and accompanying drawings but are not limited thereto.

The method of manufacturing toner of the present invention is as follows: Sending an oil phase (organic solvent composition) containing at least a binder resin, a coloring agent and a releasing agent in an organic solvent and an aqueous phase (aqueous medium) to an emulsification device equipped with a stirrer for use in the emulsification process for toner manufacturing; Continuously dispersing and/or emulsifying the aqueous phase and the oil phase in the emulsification device to granulate the oil phase; Sending the liquid dispersion and/or emulsification including the oil phase particles to a tank; and removing the solvent from the liquid dispersion and/or emulsification followed by drying. In the method, the releasing agent is preliminarily adjusted to have a dispersion particle diameter of from 0.15 to 0.7 μm before the releasing agent is contained in the oil phase. In addition, the circumferential speed of the stirrer equipped in the emulsification device is from 15 to 25 m/s. Furthermore, the volume particle diameter (DV′) of the oil phase particles at the exit of the emulsification device to the tank and the volume average particle diameter (Dv) of the oil phase particles in the tank satisfy the following relationships:

3.0≦DV′≦6.0 Relationship 1

4.0≦Dv≦7.5 Relationship 2

1.0≦Dv−Dv′≦3.0 Relationship 3.

In the manufacturing method mentioned above, when the binder resin has a characteristic peak at least at a wave number of 828 cm⁻¹ and the releasing agent has a wave number of 2,850 cm⁻¹ in an infra red spectrum obtained by a Fourier transform infrared-attenuated total reflectance (FTIR-ATR) method and a surface amount (Ws) of the releasing agent located on and near the surface of the toner particle and the total amount (Wt) of the releasing agent in the toner particle satisfy the following relationships:

0.01≦Ws/Wt≦0.05 Relationship 4

0.05≦Ws≦0.20 Relationship 5

4≦Wt≦10 Relationship 6

In the relationships, the total amount (Wt) represents a weight conversion value converted from an absorption amount of the releasing agent in the toner particle obtained by a differential scanning thermometer (DSC) and the surface amount (Ws) represents a value obtained from an intensity ratio (P2,850/P828) of the peak value (P2,850 cm⁻¹) of the releasing agent to the peak value (P828 cm⁻¹) of the binder resin.

The relationships 1 to 3 are criteria of the particle formation status (i.e., volume average particle diameter of droplets, corresponding to particles of the oil phase) when the organic solvent composition (oil phase) is continuously dispersed and/or emulsified in the aqueous medium (aqueous phase). By controlling dispersion and/or emulsification to satisfy the relationships 1 to 3, a toner satisfying the relationships 4 to 6 can be manufactured.

The values shown in the relationships 1 and 2 represent the volume average particle diameter in the liquid dispersion and/or emulsification immediately after emulsification by the emulsification device and the volume average particle diameter in the liquid dispersion and/or emulsification transported to and stored in the tank. The particle stability can be confirmed by the relationship 3, which represents the difference between the two volume average particle diameters. Meaning, when the difference obtained by the relationship 3 is small, the releasing agent tends to be difficult to expose to the surface. When the difference obtained by the relationship 3 is large, the releasing agent easily exposes to the surface.

The relationship 4 represents the ratio of the surface amount (Ws) of a releasing agent existing on or around the surface of a toner to the total amount (Wt) of the releasing agent in the toner. A small ratio thereof represents the releasing agent existing inside the toner particles and a large ratio thereof represents the releasing agent existing on or around the surface thereof. When the ratio is kept within the range of from 0.01 to 0.05, the surface amount and the total amount are well balanced and the toner has a good combination of low temperature fixability, offset resistance property and anti-filming property. The preferred range thereof is from 0.015 to 0.040. When the ratio is too small, the low temperature fixability easily deteriorates in light of friction since the ratio of the surface amount to the total amount is too small. When the ratio is too large, cold offset tends to occur due to peeling at the interface between toner particles and the anti-filming property tends to deteriorate since the ratio of the surface amount to the total amount is too large.

The relationship 5 represents the surface amount of the releasing agent on or near the surface of toner, which ranges from 0.05 to 0.20 and preferably from 0.08 to 0.18 while satisfying the relationship 4 simultaneously. When the ratio is too small, the low temperature fixability easily deteriorates in light of friction since the ratio of the surface amount to the total amount is too small. When the ratio is too large, cold offset tends to occur due to peeling at the interface between toner particles since the ratio of the surface amount to the total amount is too large.

The relationship 6 represents the total amount of the releasing agent, which ranges from 4 to 10 and preferably from 5 to 8 while satisfying the relationships 4 and 5 simultaneously. When the ratio is too small, the offset resistance property easily deteriorates irrespective of the surface amount. When the ratio is too large, the anti-filming property tends to deteriorate irrespective of the surface amount.

The surface amount (Ws) of a releasing agent existing in and on toner (mother toner particles) manufactured by the manufacturing method mentioned above from the surface to a depth of about 0.3 μm can be measured by a method based on Fourier transform infrared-attenuated total reflectance (FTIR-ATR) method. By this method, the surface amount (Ws) of a releasing agent existing in and on toner from the surface to a depth of about 0.3 μm can be obtained.

The method is as follows: Press 3 g of a sample toner at a load of 6 t for 1 minute using an automatic pellet molding device (Type M No. 50 BRP-E, manufactured by Maekawa Testing Machine Co., Ltd.) to prepare a pellet having a diameter of 40 mm with a thickness of about 2 mm; and measure the surface of this toner pellet by the FTIR-ATR method mentioned above with an FTIR microscopic device, which is prepared by implementing MultiScope FTIR unit on SpectrumOne (manufactured by PERKINELMER Co., Ltd.) with micro ATR of germanium (Ge) crystal having a diameter of 100 μm. The measurement conditions are: incident angle: 41.5°; optical resolution: 4 cm⁻¹; quantity survey: 20 times. The intensity ratio (P2,850/P828) of the peak (2,850 cm⁻¹) ascribable to the releasing agent to the peak (828 cm⁻¹) ascribable to the binder resin is calculated for 4 different places and the average value thereof is obtained.

In addition, the total amount of the releasing agent (Wt) can be measured by DSC60 (manufactured by Shimadzu Corporation).

First, about 5 mg of a sample toner is placed in an aluminum sample container. The aluminum sample container is set on a holder unit and placed in an electric furnace. The sample toner is heated from room temperature to 150° C. at a temperature raising speed of 10° C./min, left at 150° C. for 10 minutes to cool down to room temperature and left at room temperature for another 10 minutes. Thereafter, the sample toner is again heated to 150° C. at a temperature raising speed of 10° C./min in nitrogen atmosphere and DSC curve is measured by a differential scanning calorimeter (DSC) to calculate the endothermic amount of the wax (releasing agent) in the sample toner. In addition, the endothermic amount of the releasing agent is calculated in the same manner mentioned above using about 5 mg of the releasing agent. Based on both obtained endothermic amounts, the content of the releasing agent {total amount of the releasing agent (Wt)} is calculated from the following relationship A:

[Total amount (Wt) of releasing agent](% by weight)={Endothermic amount in the sample toner (J/g)}/{Endothermic amount in the releasing agent sample (J/g)}×100 Relationship A

Next, the volume average particle diameter and the particle size distribution of the particles {granulated oil phase (oil droplet)} existing in liquid dispersion/emulsification can be measured by Coulter counter method, etc. For example, Coulter Counter TA-II and Coulter Multisizer II (both are manufactured by Beckman Coulter, Inc.) can be used as the measuring equipment. Below is the description about the method for manufacturing particles (toner particle or toner):

First, add 0.1 to 5 ml of a surface active agent, preferably polyoxyethylene alkyl ether, as a dispersant to 100 to 150 ml of an electrolytic aqueous solution, which is about 1% NaCl aqueous solution prepared by using primary NaCl and pure water, for example, ISOTON-II (manufactured by Beckman Coulter, Inc.) can be used; Add 2 to 20 mg of a sample toner to the electrolytic aqueous solution; Conduct dispersion treatment for the electrolytic aqueous solution in which the measuring sample is dispersed for about 1 to 3 minutes by an ultrasonic dispersion device; Measure the volume and the number of the toner particles or the toner by the equipment mentioned above with an aperture of 100 μm; and calculate the volume distribution and the number distribution. The weight average particle diameter (Dv) and the number average particle diameter (Dn) of the toner can be obtained based on the obtained distributions.

The whole range is a particle diameter of from 2.00 to not greater than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

In the method of manufacturing toner of the present invention, the releasing agent mentioned above is dispersed in an organic solvent, i.e., an organic solvent composition (oil phase). The dispersion particle diameter of the releasing agent is already adjusted to be from 0.15 to 0.70 μm. Furthermore, the oil phase and an aqueous medium (aqueous phase) are sent to an emulsification device equipped with a stirrer which is used in the emulsification process and the oil phase is continuously dispersed and/or emulsified in the aqueous phase with the circumferential speed of the stirrer from 15 to 25 m/s.

The dispersion particle diameter of a releasing agent is known as a method for controlling the amount of the releasing agent existing on or near the surface of particles. In combination with the dispersion particle diameter, the circumferential speed of the stirrer of an emulsification device, which is a required process for granulation, can be used to control the amount of the releasing agent existing on or near the surface of particles. Meaning, when the circumferential speed of the stirrer of an emulsification device is reduced, the particle is stabilized and thus the amount of releasing agent existing on or near the surface thereof decreases. To the contrary, when the circumferential speed of the stirrer of an emulsification device increases, the particle is unstable and consequently the amount of releasing agent existing on or near the surface thereof increases.

The dispersion particle diameter (volume average particle diameter of wax particles) of a releasing agent can be measured as follows: Place and sufficiently mix 0.5 g of liquid dispersion of wax and 40 g of ethyl acetate in a 100 ml beaker; Set 100 ml of ethyl acetate in the sample input mouth of a laser diffraction particle size distribution measuring device (LA-920, manufactured by Horiba Ltd.); Circulate the liquid at the circulation speed at 5; Remove air and adjust the optical axis to perform blank measurement; Drip a preliminarily adjusted sample thereto in such a manner that the transmittance is from 80 to 90%; and subsequent to ultrasonic irradiation to the sample for 5 minutes and optical axis adjustment, the sample is measured. Thus, the particle diameter of the wax is obtained.

In the present invention, the releasing agent for use in toner manufacturing is selected from the group consisting of carnauba wax which is subject to a treatment of eliminating free aliphatic acid therefrom, rice wax, montan wax, ester wax and a combination thereof.

As the releasing agent, it is particularly preferred to use carnauba wax which is subject to a treatment of eliminating free aliphatic acid therefrom, rice wax, montan wax, or ester wax having an acid value of not greater than 5 KOHmg/g and a combination thereof in light that a releasing agent quickly oozes to the toner surface during fixing.

The weight ratio of the organic solvent composition or the polymerizable monomer composition (oil phase) to the aqueous medium (aqueous phase) is preferably from 60:40 to 20:80 and more preferably from 50:50 to 30:70. When the organic solvent composition or the polymerizable monomer composition takes too large a ratio, the emulsification status tends to be unstable so that the particles in the liquid emulsification become significantly coarse and large and the circularity thereof decreases. Furthermore, a stable particle diameter is not continuously obtained. In addition, when the aqueous medium takes too large a ratio, the circularity is easily high and severing oil droplet particles tends to be insufficient so that it is difficult to obtain a small particle diameter.

In addition, it is preferred to contain a polyester resin in the binder resin in the organic solvent composition. Polyester resins are easy to have a relatively low molecular weight in comparison with styrene acryl resins, etc. Thus, polyester resins have an excellent low temperature fixability and are suitable in terms of energy saving.

Furthermore, considering that a polymer composition, for which a reaction is already complete, is difficult to disperse or dissolve in an organic solvent, it is preferred to provide a process to uniformly introduce a polymer composition, which is desired to improve offset resistance property, in a particle. The process is that, after or during dispersion of an organic solvent composition (oil phase), in which at least a compound having an active hydrogen group, a polymer having a portion reactive with the compound, a coloring agent, and a releasing agent are dissolved or dispersed in an organic solvent, in an aqueous medium (aqueous phase) by severing, the compound having an active hydrogen group and the polymer are reacted for granulation.

The volume average particle diameter (Dv) of particles existing in the liquid dispersion/emulsification obtained by the method of the present invention is preferably from 4.0 to 7.5 μm and the ratio (Dv/Dn) of the volume average particle diameter (Dv) to the number average particle diameter (Dn) is preferably not greater than 1.20. By determining the range of the ratio (Dv/Dn), it is possible to obtain a toner for high definition and quality images. In addition, to obtain quality images, it is preferred that the volume average particle diameter of particles is from 4.0 to 7.0 μm and the ratio (Dv/Dn) is not greater than 1.17, the particles having a particle diameter of not greater than 4 μm are from 1 to 10% by number and the particles having a particle diameter of not smaller than 12.7 μm are not greater than 3% by volume. It is more preferred that the volume average particle diameter of particles is from 4.0 to 6.5 μm and the ratio (Dv/Dn) is not greater than 1.15. The toner of which the particle diameter is controlled has good developability and can form quality images for an extended period of time without scattering and fogging when the toner is used especially for a full color photocopier.

Furthermore, in the present invention, it is preferred to have a polymerization process in which a polyester based prepolymer A having an isocyanate group dispersed in an aqueous medium containing inorganic particulates and/or polymer particulates is reacted with an amine B.

Next, the materials suitable for the method of manufacturing toner of the present invention are described.

As the binder resin, it is preferred to contain a polyester resin as described above. In addition to the polyester resins, specific examples of the binder resins include, but are not limited to, styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

The polyester resin mentioned above is typically obtained by polycondensation between an alcohol and a carboxylic acid. Specific examples of such alcohols include, but are not limited to, glycols, such as ethylene glycol, diethylene glycol, triethylene glycol and propylene glycol, bisphenols such as 1,4-bis(hydroxymethyl)cyclohexane, ether bisphenols such as bisphenol A, diol monomers, and triol or higher polyol monomers. Specific examples of such carboxylic acids include maleic acid, phthalic acid, isophthalic acid, terephthalic acid, succinic acid, and malonic acid, and tri- or higher polycarboxylic acid monomers such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, 1,2,7,8-octane tetracarboxylic acid.

In the method of manufacturing toner of the present invention, prepolymers can be used. As the prepolymers, a polyester based prepolymer A containing an isocyanate group is preferred. Specific examples of polyester prepolymers (A) having an isocyanate group include, but are not limited to, a resultant of the reaction between polyisocyanate (PIC) and a polyester, i.e., a polycondensation compound having an active hydrogen group which is prepared by polyol (PO) and polycarboxylic acid (PC). Specific examples of the active hydrogen group contained in the polyesters mentioned above include, but are not limited to, hydroxyl groups (alcohol hydroxyl groups and phenol hydroxyl groups), amino groups, carboxylic groups, and mercapto groups. Among these, alcohol hydroxyl groups are particularly preferred.

Suitable polyols (PO) include diols (DIO) and polyols (TO) having three or more hydroxyl groups. It is preferred to use a diol (DIO) alone or mixtures in which a small amount of a polyol (TO) is mixed with a diol (DIO).

Specific examples of the diols (DIO) include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having from 2 to 12 carbon atoms and adducts of a bisphenol with an alkylene oxide are preferable. More preferably, adducts of a bisphenol with an alkylene oxide, or mixtures of an adduct of a bisphenol with an alkylene oxide and an alkylene glycol having from 2 to 12 carbon atoms are used. Specific examples of the polyols (TO) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Specific examples of the polyols (TO) include, but are not limited to, aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Suitable polycarboxylic acids (PC) include dicarboxylic acids (DIC) and polycarboxylic acids (TC) having three or more carboxyl groups. It is preferred to use dicarboxylic acids (DIC) alone or mixtures in which a small amount of a polycarboxylic acid (TC) is mixed with a dicarboxylic acid (DIC).

Specific examples of the dicarboxylic acids (DIC) include, but are not limited to, alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (TC) having three or more hydroxyl groups include, but are not limited to, aromatic polycarboxylic acids having from 9 to 20 carbon atoms (e.g., trimellitic acid and pyromellitic acid).

As the polycarboxylic acid (TC), anhydrides or lower alkyl esters (e.g., methyl esters, ethyl esters or isopropyl esters) of the polycarboxylic acids mentioned above can be used for the reaction with a polyol.

Suitable mixing ratio (i.e., an equivalence ratio [OH]/[COOH]) of a polyol (PO) to a polycarboxylic acid (PC) is from 2/1 to 1/1, preferably from 1.5/1 to 1/1 and more preferably from 1.3/1 to 1.02/1.

Specific examples of the polyisocyanates (PIC) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic didicosycantes (e.g., tolylene diisocyanate and diphenylmethane diisocyanate); aromatic aliphatic diisocyanates (e.g., α,α,α′,α′-tetramethyl xylylene diisocyanate); isocyanurates; blocked polyisocyanates in which the polyisocyanates mentioned above are blocked with phenol derivatives, oximes or caprolactams; etc. These compounds can be used alone or in combination.

When a polyester prepolymer (A) having an isocyanate group is obtained, a suitable mixing ratio (i.e., [NCO]/[OH]) of a polyisocyanate (PIC) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner easily deteriorates.

The content of the constitutional component of a polyisocyanate (PIC) in the polyester prepolymer (A) having a polyisocyanate group at its end portion is from 0.5 to 40% by weight, preferably from 1 to 30% by weight and more preferably from 2 to 20% by weight.

As the amines (B), polyamines and/or amines having an active hydrogen group containing a hydroxyl group or a mercapto group can be used. Specific examples of such amines include, but are not limited to, diamines (B1), polyamines (B2) having three or more amino groups, amino alcohols (B3), amino mercaptans (B4), amino acids (B5), and blocked amines (B6), in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc. Specific examples of the polyamines (B2) having three or more amino groups include diethylene triamine, triethylene and tetramine. Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids (B5) include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine (B1) is mixed with a small amount of a polyamine (B2) are preferable.

Furthermore, the molecular weight of the polyesters can be adjusted when a prepolymer (A) and an amine (B) are reacted, if desired. Specific preferred examples of the molecular weight control agent include, but are not limited to, monoamines (e.g., diethyl amine, dibutyl amine, butyl amine and lauryl amine) having no active hydrogen group, and blocked amines (i.e., ketimine compounds) prepared by blocking the monoamines mentioned above. By reaction between a polyester prepolymer (A) having an isocyanate group and an amine (B), a urea-modified polyester, which is modified by a urea linkage, is obtained. The addition amount of the molecular weight control agent is determined depending on the desired molecular weight of a produced urea-modified polyester.

The mixing ratio of the prepolymer (A) having an isocyanate group to the amines (B), i.e., the equivalent ratio ([NCO]/[NHx]) of the isocyanate group [NCO] contained in the prepolymer (A) to the amino group [NHx], where x is from 1 to 2, contained in the amines (B), is normally from 1/2 to 2/1, preferably from 1.5/1 to 1/1.5 and more preferably from 1.2/1 to 1/1.2.

Suitable colorants (coloring material) for use in the toner of the present invention include known dyes and pigments. Specific examples of the colorants include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination. The content of the colorant is from 1 to 15% by weight and preferably from 3 to 12% by weight based on the toner.

The colorants mentioned above can be used as a master batch pigment, which are prepared by combining a colorant with a resin, can be used as the colorant of the toner composition of the present invention. Specific examples of the resins for use in manufacturing of the master batch pigments or mixed and kneaded with the master batch pigments include, but are not limited to, the polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

The master batch mentioned above can be typically prepared by mixing and kneading a resin and a colorant upon application of high shear stress thereto. In this case, an organic solvent can be used to boost the interaction of the colorant with the resin. In addition, flushing methods in which an aqueous paste including a colorant is mixed with a resin solution of an organic solvent to transfer the colorant to the resin solution and then the aqueous liquid and organic solvent are separated to be removed can be preferably used because the resultant wet cake of the colorant can be used as it is. In this case, three-roll mills can be preferably used for kneading the mixture upon application of high shear stress thereto.

A charge control agent may be included as a toner component of the present invention.

Specific examples of the charge control agent include, but are not limited to, known charge control agents, for example, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc. Specific examples of the marketed products of the charge control agents include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group, for example, a sulfonate group, a carboxyl group and a quaternary ammonium group.

The content of the charge control agent is determined depending on the kind of the binder resin used, whether or not an additive is added, and the toner manufacturing method including the dispersion method. For example, the content of the charge control agent is preferably from 0.1 to 10 parts by weight, and more preferably from 0.2 to 5 parts by weight based on 100 parts by weight of the binder resin included in the toner. When the content is too high, the toner tends to have too large chargeability, which leads to reduction in the effect of a main charge control agent, and thereby the electrostatic force with a developing roller increases, resulting in deterioration of the fluidity of the toner and a decrease of the image density of toner images. The charge control agent can be melted and kneaded together with a resin in a master batch. Also, these charge control agents can be melted and kneaded with a master batch and a resin and thereafter dissolved and/or dispersed, can be directly added to an organic solvent when the toner component is dissolved or dispersed in the organic solvent, or can be fixed on the surface of toner particles after granulation of tone particles.

As an external additive to assist in improving the fluidity, developing property and charging ability of the toner particles, inorganic particulates are preferred. It is preferred for the particulate inorganic materials to have a primary particle diameter of from 5 nm to 2 μm, and more preferably from 5 nm to 500 nm. In addition, it is preferred that the specific surface area of such particulate inorganic materials measured by a BET method is from 20 to 500 m²/g. The content of the external additive is preferably from 0.01 to 5% by weight, and more preferably from 0.01 to 2.0% by weight, based on total weight of the toner.

Specific examples of such inorganic particulate materials include silica, alumina, titanium oxide, barium titanate, magnesium titanate, calciumtitanate, strontiumtitanate, zincoxide, tinoxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. It is also possible to use polymer particulates of polycondensation products or thermocuring resins such as polystyrenes, methacrylate copolymer, acrylate copolymers, silicone, benzoguanamine and nylon obtained by soap free emulsification polymerization, suspension polymerization or dispersion polymerization.

Such fluidizers can be subject to a surface treatment to improve hydrophobic property, thereby preventing deterioration of the fluidity and charging properties of a toner even in a high humid environment. Specific preferred examples of the surface preparation agents include, but are not limited to, silane coupling agents, silylation agents, silane coupling agents including a fluoroalkyl group, organic titanate coupling agents, aluminum coupling agents, silicone oil, and modified silicone oils.

As a cleaning helping agent that improves the cleaning property for removing residual toner remaining on an image bearing member or primary transfer medium after transfer, there can be used, for example, fatty acids and metal salts thereof, for example, zinc stearate, calcium stearate and stearic acid; resin particles which are prepared by a soap-free emulsion polymerization method or the like, for example, polymethyl methacrylate particles and polystyrene particles. The resin particles preferably have a narrow particle diameter distribution and the weight average particle diameter thereof is preferably from 0.01 to 1 μm.

The methods of manufacturing toner of the present invention are specifically described below but are not limited thereto. Preparation of Polyester Resin A polyol (PO) and a polycarboxylic acid (PC) are heated to 150 to 280° C. under the presence of a known esterifying catalyst such as tetrabuthoxy titanate, and dibutyltin oxide with a reduced pressure, if necessary, while water produced is removed to obtain a polyester resin.

### Preparation of Prepolymer

A polyisocyanate (PIC) is reacted with a polyester having a hydroxyl group obtained by the same manner as for the polyester mentioned above at between 40 to 140° C. to prepare a polyester prepolymer (A) having an isocyanate group. When the polyisocyanate (PIC) group is reacted, a solvent is used, if desired. Specific examples of usable solvents include, but are not limited to, compounds which are inert to an isocyanated compound, such as aromatic solvents (e.g., toluene, xylene), ketones (e.g., acetone, methylethyl ketone, methyl isobutyl ketone), esters (e.g., ethyl acetate), amides (e.g., dimethyl formamide, dimethyl acetamide), and ethers (e.g., tetrahydrofuran).

### Preparation of Modified Polyester Resin

The reaction between a polyester prepolymer (A) and an amine (B) can be conducted before or while mixing with other toner composition materials.

When preliminarily conducted, a polyester prepolymer (A) and an amine (B) are reacted at between 0 to 140° C. to obtain a urea modified polyester resin. The solvents mentioned above can be also used when a polyester prepolymer (A) and an amine (B) are reacted as in the case of preparation of a prepolymer (A).

### Manufacturing of Toner in Aqueous Medium (Aqueous Phase)

Suitable aqueous media include water, and mixtures of water with a solvent which can be mixed with water. Specific examples of such a solvent include, but are not limited to, alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc.

Toner particles are formed by reacting a dispersion body formed of a polyester prepolymer (A) having an isocyanate group with an amine (B) in an aqueous medium. A preliminarily prepared modified polyester resin can be used instead.

Toner particles can be prepared by reacting a dispersion body, in which a polyester prepolymer (A) having an isocyanate group is dispersed in an aqueous medium, with an amine (B).

In order to prepare a dispersion body in which a prepolymer (A) is stably dispersed in an aqueous medium, a method, in which toner constituents including a polyester resin and/or a polyester prepolymer (A) are added into an aqueous medium and then dispersed upon application of mechanical shear stress, is preferably used. A prepolymer (A) and other toner constituents such as colorants, release agents (waxes) and charge controlling agents, may be added into an aqueous medium at the same time when the dispersion body is prepared. However, it is preferred that the toner constituents be previously mixed and then the mixed toner constituents be added to the aqueous medium for dispersion. In addition, toner constituents such as colorants, release agents (waxes), and charge controlling agents are not necessarily added to the aqueous dispersion when particles are formed, and may be added thereto after particles are prepared in the aqueous medium.

### Solid Particulate Dispersant

In addition, by preliminarily adding a solid particulate dispersant to an aqueous medium (aqueous phase), it is possible to uniformly disperse oil droplets in the aqueous medium. This occurs because the solid particulate dispersant is arranged on the surface of the oil droplets during dispersion so that the dispersion of the oil droplets is unified. Furthermore, attachment of the oil droplets each other is prevented, which makes it possible to obtain a toner having a sharp particle size distribution. Solid particulate dispersants are hardly soluble in an aqueous medium and an inorganic particulate having an average particle diameter of from 0.01 to 1 μm is preferred. Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. It is preferred to use calcium phosphate, colloidal titanium oxide, colloidal silica, and hydroxyapatite. Among them, hydroxyapatite, which is synthesized by the reaction of sodium phosphate and calcium chloride in water under the basic condition, is especially preferred.

Specific examples of the dispersants which are used for dispersing or emulsifying an oil phase in which toner constituents are dissolved or dispersed in an aqueous liquid, include, but are not limited to, anionic surfactants such as alkylbenzene sulfonic acid salts, a-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group is effective in an extremely small amount. Specific preferred examples of anionic surfactants having a fluoroalkyl group include, but are not limited to, fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium 3-{omega-fluoroalkanoyl(C6-C8)-N-ethylamino}-1-propanesulfonate, fluoroalkyl(C11-C20)carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surfactants having a fluoroalkyl group include, but are not limited to, SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants, which can be used for dispersing an oil phase including toner constituents in water, include primary, secondary and tertiary aliphatic amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLON S-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

Further, it is possible to stably disperse toner constituents in water using a polymeric protection colloid. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds; acid chlorides (e.g., acrylic acid chloride and methacrylic acid chloride); and monomers having a nitrogen atom or an alicyclic ring having a nitrogen atom (e.g., vinyl pyridine, vinyl pyrrolidone, vinyl imidazole and ethylene imine).

In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

When compounds such as calcium phosphate which are soluble in an acid or alkali are used as a dispersion stabilizer, it is preferable to dissolve calcium phosphate by adding an acid such as hydrochloric acid and to wash the resultant particles with water to remove calcium phosphate therefrom. In addition, such a dispersion stabilizer can be removed using a decomposition method using an enzyme.

When a dispersant is used, the dispersant is not necessarily washed away from the surface of the toner particle. However, it is preferred to wash and remove the dispersant after elongation and/or cross linking reaction in light of chargeability.

The elongation and/or cross linking time is selected depending on the reactivity, which is determined by the combination of the structure of the isocyanate group contained in a polyester prepolymers (A) and an amine (B). However, the time is in general from 10 minutes to 40 hours, and preferably from 2 to 24 hours. The reaction temperature is generally from 0 to 150° C., and preferably from 40 to 98° C. In addition, a known catalyst such as dibutyltin laurate and dioctyltin laurate can be optionally used for the reaction.

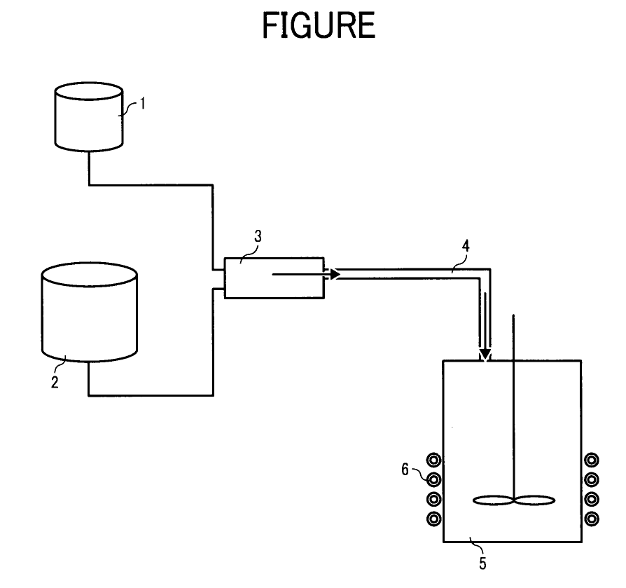

In the method of manufacturing toner of the present invention, as illustrated in FIG. 1, after an oil phase 1 and an aqueous phase 3 are sent to an emulsification device 3 equipped with a stirrer to continuously disperse and/or emulsify the oil phase 1 for granulation, the liquid dispersion and/or emulsification containing the granulated particles are sent to a tank 5 through a pipeline 4. This tank 5 preferably has a structure suitable for removing an organic solvent from the liquid dispersion and/or emulsification. That is, any known tank structured to have a stirrer and a heating device 6 (jacket or a heater) to heat the tank can be used. To efficiently remove an organic solvent, it is preferred to have a structure equipped with a pressure reduction device or a device which can pour compressed air or nitrogen, etc. Especially, a structure having multiply separated jackets or heaters is preferred.

After removing the organic solvent from the liquid dispersion and/or emulsification and drying treatment, the thus prepared powder (mother toner particles) can be mixed with other particles of, for example, a charge control agent, a fluidizing agent and a coloring material. Such particles can be fixed on the toner particles by applying a mechanical impact to the mixed powder to integrate (fix) the particles with toner particles. Thus, the other particles can be prevented from being detached from the toner particles. Specific examples of such mechanical impact application methods include, but are not limited to, a method in which a mixture is mixed by a blade rotating at a high speed and a method in which a mixture is put into a jet air to collide the particles against each other or a collision plate.

Specific examples of such mechanical impact applicators include, but are not limited to, ONG MILL (manufactured by Hosokawa Micron Co., Ltd.), modified I TYPE MILL (manufactured by Nippon Pneumatic Mfg. Co., Ltd.) in which the pressure of air used for pulverization is reduced, HYBRIDIZATION SYSTEM (manufactured by Nara Machine Co., Ltd.), KRYPTRON SYSTEM (manufactured by Kawasaki Heavy Industries, Ltd.), automatic mortars, etc.

Furthermore, the toner obtained by the manufacturing method of the present invention can be used as a magnetic toner including a magnetic material. Specific examples of the magnetic materials include, but are not limited to, oxidized iron such as magnetite, hematite and ferrite, metals such as iron, cobalt and nickel, or an alloyed metal thereof with aluminum, cobalt, copper, lead, magnesium, tin, zinc, antimony, beryllium, bismuth, cadmium, calcium, manganese, selenium, titanium, tungsten and vanadium, and a mixture thereof. Among these, magnetite is preferred in terms of magnetic characteristics. These electromagnetic materials preferably have an average particle diameter of from about 0.1 to about 2 μm. The content thereof is from about 15 to about 200 parts by weight and preferably from 20 to 100 parts by weight based on 100 parts by weight of the resin component.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

### Manufacturing of Polyester

690 parts of an adduct of bisphenol A with 2 mol of ethylene oxide and 335 parts of terephthalic acid are placed in a reaction container equipped with a condenser, a stirrer and a nitrogen introduction tube to conduct a condensation reaction at 210° C. for 10 hours in nitrogen atmosphere. Next, the reaction is continued for 5 hours with a reduced pressure of 10 to 15 mmHg while dehydrating. Subsequent to cooling down, Polyester (1) is obtained. The weight average particle diameter of the resin of the obtained Polyester (1) is 6,000, the acid value thereof is 10 KOHmg/g and the glass transition temperature thereof is 48° C.

### Manufacturing of Prepolymer

In a reaction container equipped with a condenser, a stirrer and a nitrogen introduction tube, 795 parts of an adduct of bisphenol A with 2 mole of ethylene oxide, 200 parts of isophthalic acid, 65 parts of terephthalic acid and 2 parts of dibutyltin oxide are placed to conduct a condensation reaction at 210° C. for 8 hours. Next, the reaction is continued for 5 hours with a reduced pressure of 10 to 15 mmHg while dehydrating. Subsequent to cooling down to 80° C., the resultant is reacted with 170 parts of isophorone diisocyanate in ethyl acetate for 2 hours and thus Prepolymer (1). The weight average particle diameter of the obtained Prepolymer (1) is 5,000.

### Manufacturing of Liquid Dispersion of Wax

1,080 parts of ethyl acetate, 420 parts of Polyester (1), 140 parts of carnauba wax and 21 parts of a wax dispersant (styrene-acrylonitrile-butylacrylate copolymer, copolymerization ratio: 80:10:10 mol %) are placed in a tank and heated to 74° C. to be sufficiently dissolved. The solution is cooled down to 30° C. for precipitation. The resultant is dispersed with and retained in a bead mill (manufactured by Ashizawa Finetech Ltd.), in which beads having a particle diameter of 0.5 mm are enclosed, at 500 rpm for 7 minutes. Thus, Liquid dispersion of wax (1) having a particle diameter of 0.51 μm is obtained.

### Manufacturing of Organic Solvent Composition (Oil Phase)

170 parts of the Liquid dispersion of wax (1) described above, 120 parts of the Polyester (1), 20 parts of PY155 (manufactured by Clariant), 70 parts of ethyl acetate, and 2 parts of isophorone diamine are placed in a tank and stirred for 2 hours for dissolution and mixing. Next, the resultant is circulation-mixed with a high efficiency dispersion device (EBARA MILDER, manufactured by Ebara Corporation) for one hour to obtain Organic solvent composition (1). The acid value of the obtained Organic solvent composition (1) is 4.5 KOHmg/g.

25 parts of the Prepolymer (1) and 25 parts of ethyl acetate are placed in another tank and stirred for 4 hours for dissolution and mixing. Thus, Organic solvent composition (2) is obtained. Manufacturing of Aqueous Dispersion Medium (Aqueous Phase)

945 parts of water, 40 parts of 20% aqueous liquid dispersion of a copolymer of styrene-methacrylic acid-butyl acrylate, 160 parts of 50% dodecylphenyl ether sodium disulphonate aqueous solution (EREMINOR MON-7 from Sanyo Chemical Industries Ltd.), and 90 parts of ethyl acetate are placed in a tank followed by mixing and stirring. Thus, Aqueous dispersion medium (1) is obtained.

### Manufacturing of Toner

The organic solvent composition (1), the Organic solvent composition (2) and the Aqueous dispersion medium (1) are provided to an emulsification device (pipeline homomixer, manufactured by Tokushu Kika Kogyo Co., Ltd.) equipped with a stirrer at 4,050 g/min, 500 g/min and 8,450 g/min, respectively and continuously dispersed and/or emulsified at a circumferential speed of 17 m/s for 60 minutes. Thus, 700 Kg of liquid dispersion and emulsification (hereinafter referred to as liquid emulsified dispersion) is obtained. In the stable emulsification stage, a sample is taken from the sampling mouth located 50 cm away from the exit of the emulsification device and the particle size thereof is measured. The volume average particle diameter (Dv) of the particles in the liquid emulsification is 4.2 μm and the ratio (Dv/Dn) of the volume average particle diameter (Dv) to the number average particle diameter (Dn) is 1.16. The liquid emulsification can be stored in an amount of 1,000 kg at maximum and is stored in a tank made of SUS having a structure of two portions of warm water jackets, which are 400 kg and 800 kg, with a reduced pressure line. The volume average particle diameter (Dv′) of the particles in the liquid emulsification in the tank is 6.2 μm and the ratio (Dv′/Dn) of the volume average particle diameter (Dv) to the number average particle diameter is 1.12. The tank is equipped with a stirrer.

The organic solvent is removed while using the tank as follows: Raise the temperature to 45° C.; Gradually reduce the pressure while stirring with the stirrer at a circumferential speed of 10.5 m/s and avoiding bumping to remove the organic solvent in the final condition of −90 kPa to atmospheric pressure at last; Remove the organic solvent takes 5 hours; Heat the resultant to 60° C. and conduct a 5 hour additional reaction followed by filtration, washing and drying. Thus, mother toner particles are obtained.

Next, 100 parts of the obtained mother toner particle and 0.25 parts of a charge control agent (BONTRON E-84, manufactured by Orient Chemical Industries Co., Ltd.) are mixed by a Q type mixer (Mitsui Mining Company, Limited). Then, 0.5 parts of hydrophobic silica (H2000, manufactured by Clariant) are admixed therewith. Furthermore, 0.5 parts of hydrophobic silica and 0.5 parts of hydrophobized titanium oxide are mixed by a HENSCEL MIXER. Subsequent to removal of coarse particles with a screen having an opening of 37 μm, Yellow toner (1) is obtained.

### Example 2

### Manufacturing of Liquid Dispersion of Wax

Liquid dispersion of wax (2) having a wax particle diameter of 0.16 μm is obtained in the same manner as in Example 1 except that the bead particle diameter in Example 1 is changed to 0.3 mm and the rotation speed of the bead mill is changed to 600 rpm and the stored time in the bead mill is change to 10 minutes.

### Manufacturing of Organic Solvent Composition

Organic solvent composition (3) is obtained in the same manner as in Example 1 except that the Liquid dispersion of wax (1) is changed to the Liquid dispersion of wax (2).

### Manufacturing of Toner

Yellow toner (2) is obtained in the same manner as in Example 1 except that the Organic solvent composition (1) is changed to the Organic solvent composition (3) with a provision speed of 3,240 g/min and the provision speed of the Organic solvent composition (2) is changed to 400 g/min, the Aqueous dispersion medium (1) is provided at 6,760 g/min and the circumferential speed is changed to 15 m/s.

### Example 3

### Manufacturing of Liquid Dispersion of Wax

Liquid dispersion of wax (3) having a wax particle diameter of 0.66 μm is obtained in the same manner as in Example 1 except that the rotation speed of the bead mill is changed to 400 rpm and the stored time in the bead mill is changed to 5 minutes.

### Manufacturing of Organic Solvent Composition

Organic solvent composition (4) is obtained in the same manner as in Example 1 except that the Liquid dispersion of wax (1) is changed to the Liquid dispersion of wax (3).

### Manufacturing of Toner

Yellow toner (3) is obtained in the same manner as in Example 1 except that the Organic solvent composition (1) is changed to the Organic solvent composition (4) with a provision speed of 5,265 g/min and the provision speed of the Organic solvent composition (2) is changed to 650 g/min, the Aqueous dispersion medium (1) is provided at 11,320 g/min and the circumferential speed is changed to 24 m/s.

### Example 4

### Manufacturing of Liquid Dispersion of Wax

Liquid dispersion of wax (4) having a wax particle diameter of 0.40 μm is obtained in the same manner as in Example 1 except that the rotation speed of the bead mill is changed to 600 rpm.

### Manufacturing of Organic Solvent Composition

Organic solvent composition (5) is obtained in the same manner as in Example 1 except that the Liquid dispersion of wax (1) is changed to the Liquid dispersion of wax (4).

### Manufacturing of Toner

Yellow toner (4) is obtained in the same manner as in Example 1 except that the Organic solvent composition (1) is changed to the Organic solvent composition (5) and the circumferential speed is changed to 16 m/s.

### Example 5

### Manufacturing of Liquid Dispersion of Wax

Liquid dispersion of wax (5) having a wax particle diameter of 0.59 μm is obtained in the same manner as in Example 1 except that the rotation speed of the bead mill is changed to 400 rpm.

### Manufacturing of Organic Solvent Composition (Oil Phase)

170 parts of the Liquid dispersion of wax (5) described above, 120 parts of the Polyester (1), 16 parts of PR1022 (manufactured by DIC Corporation), 74 parts of ethyl acetate, and 2 parts of isophorone diamine are placed in a tank and stirred for 2 hours for dissolution and mixing. Next, the resultant is circulation-mixed with a high efficiency dispersion device (EBARA MILDER, manufactured by Ebara Corporation) for one hour to obtain Organic solvent composition (6).

### Manufacturing of Aqueous Dispersion Medium (Aqueous Phase)

945 parts of water, 40 parts of 20% aqueous liquid dispersion of a copolymer of styrene-methacrylic acid-butyl acrylate, 175 parts of 50% dodecylphneyl ether sodium disulphonate aqueous solution (EREMINOR MON-7 from Sanyo Chemical Industries Ltd.), and 90 parts of ethyl acetate are placed in a tank followed by mixing and stirring. Thus, Aqueous dispersion medium (2) is obtained.

### Manufacturing of Toner

Magenta toner (1) is obtained in the same manner as in Example 1 except that the Organic solvent composition (1) is changed to the Organic solvent composition (6) with a provision speed of 5,275 g/min and the provision speed of the Organic solvent composition (2) is changed to 650 g/min, the Aqueous dispersion medium (2) is provided at 9,670 g/min and the circumferential speed is changed to 20 m/s.

### Example 6

### Manufacturing of Toner

Magenta toner (2) is obtained in the same manner as in Example 1 except that the Organic solvent composition (1) is changed to the Organic solvent composition (6) with a provision speed of 4,835 g/min and the provision speed of the Organic solvent composition (2) is changed to 600 g/min, the Aqueous dispersion medium (2) is provided at 8,865 g/min and the circumferential speed is changed to 18 m/s.

### Example 7

### Manufacturing of Organic Solvent Composition (Oil Phase)

170 parts of the Liquid dispersion of wax (1) described above, 120 parts of the Polyester (1), 16 parts of LIONOL BLUE FG-7351 (manufactured by Toyo Ink Mfg. Co., Ltd.), 74 parts of ethyl acetate, and 2 parts of isophorone diamine are placed in a tank and stirred for 2 hours for dissolution and mixing. Next, the resultant is circulation-mixed with a high efficiency dispersion device (EBARA MILDER, manufactured by Ebara Corporation) for one hour to obtain Organic solvent composition (7).

### Manufacturing of Aqueous Dispersion Medium (Aqueous Phase)

945 parts of water, 40 parts of 20% aqueous liquid dispersion of a copolymer of styrene-methacrylic acid-butyl acrylate, 150 parts of 50% dodecylphneyl ether sodium disulphonate aqueous solution (EREMINOR MON-7 from Sanyo Chemical Industries Ltd.), and 90 parts of ethyl acetate are placed in a tank followed by mixing and stirring. Thus, Aqueous dispersion medium (3) is obtained.

### Manufacturing of Toner

Cyan toner (1) is obtained in the same manner as in Example 1 except that the Organic solvent composition (1) is changed to the Organic solvent composition (7) with a provision speed of 4,860 g/min and the provision speed of the Organic solvent composition (2) is changed to 600 g/min, the Aqueous dispersion medium (3) is provided at 7,540 g/min and the circumferential speed is changed to 19 m/s.

### Example 8

### Manufacturing of Liquid Dispersion of Wax

Liquid dispersion of wax (6) having a wax particle diameter of 0.62 μm is obtained in the same manner as in Example 1 except that the rotation speed of the bead mill is changed to 400 rpm and the stored time in the bead mill is changed to 6 minutes.

### Manufacturing of Organic Solvent Composition

Organic solvent composition (8) is obtained in the same manner as in Example 1 except that the Liquid dispersion of wax (1) is changed to the Liquid dispersion of wax (6).

### Manufacturing of Toner

Cyan toner (2) is obtained in the same manner as in Example 1 except that the Organic solvent composition (1) is changed to the Organic solvent composition (8) with a provision speed of 5,345 g/min and the provision speed of the Organic solvent composition (2) is changed to 660 g/min, the Aqueous dispersion medium (3) is provided at 8,290 g/min and the circumferential speed is changed to 19 m/s.

### Comparative Example 1

### Manufacturing of Organic Solvent Composition

Organic solvent composition (9) is obtained in the same manner as in Example 1 except that the Liquid dispersion of wax (1) is changed to the Liquid dispersion of wax (6).

### Manufacturing of Toner

Yellow toner (5) is obtained in the same manner as in Example 1 except that the Organic solvent composition (1) is changed to the Organic solvent composition (9) with a provision speed of 4,455 g/min and the provision speed of the Organic solvent composition (2) is changed to 550 g/min, the Aqueous dispersion medium (1) is provided at 9,295 g/min and the circumferential speed is changed to 19 m/s.

### Comparative Example 2

### Manufacturing of Liquid Dispersion of Wax

Liquid dispersion of wax (7) having a wax particle diameter of 0.35 μm is obtained in the same manner as in Example 1 except that the bead particle diameter in Example 1 is changed to 0.3 mm, the rotation speed of the bead mill is changed to 500 rpm and the stored time in the bead mill is change to 6 minutes.

### Manufacturing of Organic Solvent Composition

Organic solvent composition (10) is obtained in the same manner as in Example 1 except that the Liquid dispersion of wax (1) is changed to the Liquid dispersion of wax (7).

### Manufacturing of Toner

Yellow toner (6) is obtained in the same manner as in Example 1 except that the Organic solvent composition (1) is changed to the Organic solvent composition (10) and the circumferential speed is changed to 16 m/s.

### Comparative Example 3

### Manufacturing of Liquid Dispersion of Wax

Liquid dispersion of wax (8) having a wax particle diameter of 0.44 μm is obtained in the same manner as in Example 1 except that the rotation speed of the bead mill is changed to 600 rpm and the stored time in the bead mill is changed to 6 minutes.

### Manufacturing of Organic Solvent Composition

Organic solvent composition (11) is obtained in the same manner as in Example 1 except that the Liquid dispersion of wax (1) is changed to the Liquid dispersion of wax (8).

### Manufacturing of Toner

Yellow toner (7) is obtained in the same manner as in Example 1 except that the Organic solvent composition (1) is changed to the Organic solvent composition (11).

### Manufacturing of Toner

Magenta toner (3) is obtained in the same manner as in Example 1 except that the Organic solvent composition (1) is changed to the Organic solvent composition (6) with a provision speed of 5,275 g/min and the provision speed of the Organic solvent composition (2) is changed to 650 g/min, the Aqueous dispersion medium (1) is provided at 9,980 g/min and the circumferential speed is changed to 22 m/s.

### Comparative Example 5

### Manufacturing of Organic Solvent Composition

Organic solvent composition (12) is obtained in the same manner as in Example 5 except that the Liquid dispersion of wax (5) in Example 5 is changed to the Liquid dispersion of wax (3).

### Manufacturing of Toner

Magenta toner (4) is obtained in the same manner as in Example 1 except that the Organic solvent composition (1) is changed to the Organic solvent composition (12) with a provision speed of 5,715 g/min and the provision speed of the Organic solvent composition (2) is changed to 705 g/min, the Aqueous dispersion medium (1) is provided at 10,480 g/min and the circumferential speed is changed to 23 m/s.

### Comparative Example 6

### Manufacturing of Organic Solvent Composition

Organic solvent composition (13) is obtained in the same manner as in Example 7 except that the Liquid dispersion of wax (7) in Example 7 is changed to the Liquid dispersion of wax (8).

### Manufacturing of Toner

Cyan toner (3) is obtained in the same manner as in Example 1 except that the Organic solvent composition (1) is changed to the Organic solvent composition (13) with a provision speed of 5,830 g/min and the provision speed of the Organic solvent composition (2) is changed to 720 g/min, the Aqueous dispersion medium (3) is provided at 9,050 g/min and the circumferential speed is changed to 21 m/s.

### Comparative Example 7

### Manufacturing of Liquid Dispersion of Wax

Liquid dispersion of wax (15) having a wax particle diameter of 0.55 μm is obtained in the same manner as in Example 1 except that the rotation speed of the bead mill is changed to 500 rpm and the stored time in the bead mill is change to 6 minutes.

### Manufacturing of Organic Solvent Composition

Organic solvent composition (14) is obtained in the same manner as in Example 7 except that the Liquid dispersion of wax (7) in Example 7 is changed to the Liquid dispersion of wax (15).

### Manufacturing of Toner

Cyan toner (4) is obtained in the same manner as in Example 1 except that the Organic solvent composition (1) is changed to the Organic solvent composition (14) with a provision speed of 5,830 g/min and the provision speed of the Organic solvent composition (2) is changed to 720 g/min, the Aqueous dispersion medium (3) is provided at 9,050 g/min and the circumferential speed is changed to 20 m/s.

The dispersion particle diameters (wax particle diameters), the circumference speed of the stirrer of the emulsification device, volume average particle diameter (Dv′) of particles of liquid dispersion/emulsification at the exit of the emulsification device, the volume average particle diameters (Dv) of particles in the liquid dispersion/emulsification in the tank, the ratios (Dv/Dn) of Dv to the number average particle diameters (Dn), Dv−Dv′, amount of the releasing agent on surface (Ws) (amount of surface wax), total amount of releasing agent (Wt) (total wax amount), and Ws/Wt of Examples 1 to 8 and Comparative Examples 1 to 7 are shown in Tables 1, 2-1 and 2-2 with the evaluation results described below.

The fixing property is evaluated with regard to Yellow toners (1) to (4), Magenta toners (1) and (2) and Cyan toners (1) and (2) manufactured in Examples 1 to 8. In addition, Yellow toners (5) to (7), Magenta toners (3) and (4) and Cyan toners (3) and (4) are evaluated in the same manner for comparison. The evaluation results are shown in Tables 1, 2-1 and 2-2. The evaluation method is as follows.

### Fixing Property

### (1) Analogue Smear (Temperature at When Smear Occurs)

Solid images are produced by a remodeled image forming apparatus based on imagio Neo 450 (manufactured by Ricoh Co., Ltd.) using TYPE 6200 paper (manufactured by Ricoh Co., Ltd.) while the image density is adjusted to the range of from 0.65 to 0.85 mg/cm² and the temperature of the fixing roller is made variable from 140 to 190° C. with an interval of 5° C. Next, white cotton cloth (JIS L0803 Cotton No. 3) is attached to the friction element of the clockmeter (A.A.T.C.C. CROCK METER MODEL CM-1, manufactured by Atlas Electric Devices Co.) with a double stick tape. The solid images are placed on a test table and abraded five times with a width of from 40 to 60 mm. The abraded white cotton cloth is removed and the image density at the portion contaminated by the toner is measured. The temperature at when smear occurs (hereinafter referred to as smear occurrence temperature) is defined as the fixing temperature when the image density cannot keep 0.4 or higher. The smear occurrence temperature is evaluated according to the following criteria:
Excellent: 155° C. or lower
Good: 156° C. to 165° C.
Bad: 166° C. or higher

### (2) Cold Offset (Temperature at When Cold Offset Occurs)

Solid images are produced by a remodeled apparatus based on imagio Neo 450 (manufactured by Ricoh Co., Ltd.) using TYPE 6200 paper (manufactured by Ricoh Co., Ltd.) while the image density is adjusted to the range of from 0.65 to 0.85 mg/cm² and the temperature of the fixing roller is made variable from 140 to 190° C. with an interval of 5° C. The cold offset property is evaluated based on the temperature at when cold offset does not occur to paper (hereinafter referred to as the cold offset occurrence temperature) according to the following criteria.
Cold offset occurrence temperature: 165° C. or lower (Excellent)
   166° C. to 175° C. (Good)
   176° C. or higher (Bad)
      (3) Hot offset (Temperature at When Hot Offset Occurs)

Solid images are produced by a remodeled apparatus based on imagio Neo 450 (manufactured by Ricoh Co., Ltd.) using TYPE 6200 paper (manufactured by Ricoh Co., Ltd.) while the image density is adjusted to the range of from 0.75 to 0.95 mg/cm² and the temperature of the fixing roller is made variable from 160 to 220° C. with an interval of 5° C. The hot offset property is evaluated based on the temperature at when hot offset does not occur to paper (hereinafter referred to as the hot offset occurrence temperature) according to the following criteria.
Cold offset occurrence temperature: 200° C. or higher (Excellent)
   185° C. to 199° C. (Good)
   184° C. or higher (Bad)

### (4) Image Bearing Member Filming Property (Filming Rank)

100% solid images are produced by an image forming apparatus (IPSiO 8000, manufactured by Ricoh Co., Ltd.) in a single color mode with a run length of 1,000 sheets. Filming on the image bearing member is compared with the example at each stage and evaluated into 9 ranks of Rank 1 to Rank 5 with a difference of 0.5. In addition, the filming material on the image bearing member is previously confirmed to be wax by using a Fourier transform infrared-attenuated total reflectance (FTIR-ATR) device (Spectrum One, manufactured by The Perkin-Elmer Corporation). At Rank 5, filming occurs least, meaning that filming is hardly seen and at Rank 1, filming occurs most. Filming is evaluated as follows:
Excellent: Rank 4.5 and Rank 5
Good: Rank 3.5 and Rank 4
Bad: Rank 3 and lower

TABLE 1

| | Example 1 | Example 2 | Example 3 | Example 4 | Example 5 | Example 6 | Example 7 | Example 8 |
|---|---|---|---|---|---|---|---|---|
| Ws | 0.154 | 0.054 | 0.197 | 0.082 | 0.18 | 0.193 | 0.135 | 0126 |
| Wt | 6.5 | 5.1 | 4.2 | 5.4 | 5 | 9.8 | 7.8 | 4.1 |
| Ws/Wt | 0.024 | 0.011 | 0.047 | 0.015 | 0.036 | 0.020 | 0.017 | 0.031 |
| Dv′ (μm) | 4.2 | 5.6 | 3.2 | 4.3 | 3.8 | 4.3 | 5.8 | 3.8 |
| Dv (μm) | 6.2 | 6.7 | 6.1 | 5.6 | 6.5 | 5.9 | 7.4 | 6.1 |
| Dv/Dn | 1.11 | 1.13 | 1.12 | 1.14 | 1.14 | 1.13 | 1.15 | 1.12 |
| Dv − Dv′ (μm) | 2.0 | 1.1 | 2.9 | 1.3 | 2.7 | 1.6 | 1.6 | 2.3 |
| Wax particle | 0.51 | 0.16 | 0.71 | 0.4 | 0.59 | 0.59 | 0.51 | 0.62 |
| diameter | | | | | | | | |
| (μm) | | | | | | | | |
| Circumference | 17 | 15 | 24 | 16 | 20 | 18 | 16 | 19 |
| speed (m/s) | | | | | | | | |
| Smear | 150 | 165 | 145 | 160 | 145 | 145 | 150 | 155 |
| occurrence | E | G | E | G | E | E | E | E |
| temperature | | | | | | | | |
| (° C.) | | | | | | | | |
| Cold offset | 160 | 150 | 175 | 155 | 165 | 170 | 160 | 160 |
| occurrence | E | E | G | E | E | G | E | E |
| temperature | | | | | | | | |
| (° C.) | | | | | | | | |
| Hot offset | 210 | 200 | 185 | 205 | 200 | 215 | 210 | 185 |
| occurrence | E | E | G | E | E | E | E | G |
| temperature | | | | | | | | |
| (° C.) | | | | | | | | |
| Filming rank | 5 | 5 | 4 | 5 | 5 | 3.5 | 4.5 | 5 |
| evaluation | E | E | G | E | E | G | E | E |

E: Excellent
G: Good

TABLE 2-1

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Ws | 0.154 | 0.054 | 0.197 | 0.082 | 0.18 | 0.193 | 0.135 |
| Wt | 6.5 | 5.1 | 4.2 | 5.4 | 5 | 9.8 | 7.8 |
| Ws/Wt | 0.024 | 0.011 | 0.047 | 0.015 | 0.036 | 0.020 | 0.017 |
| Dv′ (μm) | 4.2 | 5.6 | 3.2 | 4.3 | 3.8 | 4.3 | 5.8 |
| Dv (μm) | 6.2 | 6.7 | 6.1 | 5.6 | 6.5 | 5.9 | 7.4 |
| Dv/Dn | 1.11 | 1.13 | 1.12 | 1.14 | 1.14 | 1.13 | 1.15 |
| Dv − Dv′ (μm) | 2.0 | 1.1 | 2.9 | 1.3 | 2.7 | 1.6 | 1.6 |
| Wax particle | 0.51 | 0.16 | 0.71 | 0.4 | 0.59 | 0.59 | 0.51 |
| diameter | | | | | | | |
| (μm) | | | | | | | |
| Circumference | 17 | 15 | 24 | 16 | 20 | 18 | 16 |
| speed (m/s) | | | | | | | |
| Smear | 150 | 165 | 145 | 160 | 145 | 145 | 150 |
| occurrence | E | G | E | G | E | E | E |
| temperature | | | | | | | |
| (° C.) | | | | | | | |
| Cold offset | 160 | 150 | 175 | 155 | 165 | 170 | 160 |
| occurrence | E | E | G | E | E | G | E |
| temperature | | | | | | | |
| (° C.) | | | | | | | |
| Hot offset | 210 | 200 | 185 | 205 | 200 | 215 | 210 |
| occurrence | E | E | G | E | E | E | E |
| temperature | | | | | | | |
| (° C.) | | | | | | | |
| Filming rank | 5 | 5 | 4 | 5 | 5 | 3.5 | 4.5 |
| evaluation | E | E | G | E | E | G | E |

TABLE 2-2

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Ws | 0.154 | 0.054 | 0.197 | 0.082 | 0.18 | 0.193 | 0.135 |
| Wt | 6.5 | 5.1 | 4.2 | 5.4 | 5 | 9.8 | 7.8 |
| Ws/Wt | 0.024 | 0.011 | 0.047 | 0.015 | 0.036 | 0.020 | 0.017 |
| Dv′ (μm) | 4.2 | 5.6 | 3.2 | 4.3 | 3.8 | 4.3 | 5.8 |
| Dv (μm) | 6.2 | 6.7 | 6.1 | 5.6 | 6.5 | 5.9 | 7.4 |
| Dv/Dn | 1.11 | 1.13 | 1.12 | 1.14 | 1.14 | 1.13 | 1.15 |
| Dv − Dv′ (μm) | 2.0 | 1.1 | 2.9 | 1.3 | 2.7 | 1.6 | 1.6 |
| Wax particle | 0.51 | 0.16 | 0.71 | 0.4 | 0.59 | 0.59 | 0.51 |
| diameter | | | | | | | |
| (μm) | | | | | | | |
| Circumference | 17 | 15 | 24 | 16 | 20 | 18 | 16 |
| speed (m/s) | | | | | | | |
| Smear | 150 | 165 | 145 | 160 | 145 | 145 | 150 |
| occurrence | E | G | E | G | E | E | E |
| temperature | | | | | | | |
| (° C.) | | | | | | | |
| Cold offset | 160 | 150 | 175 | 155 | 165 | 170 | 160 |
| occurrence | E | E | G | E | E | G | E |
| temperature | | | | | | | |
| (° C.) | | | | | | | |
| Hot offset | 210 | 200 | 185 | 205 | 200 | 215 | 210 |
| occurrence | E | E | G | E | E | E | E |
| temperature | | | | | | | |
| (° C.) | | | | | | | |
| Filming rank | 5 | 5 | 4 | 5 | 5 | 3.5 | 4.5 |
| evaluation | E | E | G | E | E | G | E |

As seen in the results shown in Tables 1, 2-1 and 2-2, Yellow toners (1) to (4), Magenta toners (1) and (2) and Cyan toners (1) and (2) of Examples 1 to 8 of the present invention are good or excellent with regard to the fixing properties. To the contrary, Yellow toners (5) to (7), Magenta toners (3) and (4) and Cyan toners (3) and (4) of Comparative Examples 1 to 7 are unsatisfactory with regard to at least one of the fixing properties.

Namely, According to the method of manufacturing toner of the present invention, a toner having a good low temperature fixing property for abrasion, a good cold offset resistance, a good hot offset resistance, and an anti-filming property can be obtained irrespective of the content of a releasing agent. Thus, quality images can be formed for an extended period of time when the toner is used for a full color photocopiers, etc.

This document claims priority and contains subject matter related to Japanese Patent Application No. 2007-144821, filed on May 31, 2007, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A method of manufacturing toner comprising:
adding an oil phase comprising an organic solvent in which a binder resin, a coloring agent and a releasing agent are dissolved or dispersed and an aqueous phase to an emulsification device equipped with a stirrer,
continuously dispersing or emulsifying the oil phase and the aqueous phase in the emulsification device equipped with a stirrer to form a liquid dispersion or emulsion comprising oil phase particles;
transporting the liquid dispersion or emulsion to a tank;
removing the organic solvent from the liquid dispersion or emulsion followed by drying to form mother toner particles,
wherein the releasing agent has been preliminarily prepared to have a dispersion diameter of from 0.15 to 0.7 μm before the releasing agent is contained in the oil phase, a circumferential speed of the stirrer is from 15 to 25 m/s, and a volume particle diameter (DV′) of the oil phase particles at an exit of the emulsification device to the tank and a volume average particle diameter (Dv) of the oil phase particles in the tank satisfy the following relationships:
3.0≦DV′≦6.0 Relationship 1
4.0≦Dv≦7.5 Relationship 2
1.0≦Dv−Dv′≦3.0 Relationship 3.

2. The method of manufacturing toner according to claim 1, wherein the binder resin has a characteristic peak at least at a wave number of 828 cm⁻¹ and the releasing agent has a wave number of 2,850 cm⁻¹ in an infrared spectrum obtained by a Fourier transform infrared-attenuated total reflectance (FTIR-ATR) method and a surface amount (Ws) of the releasing agent located on or near a surface of the toner and a total amount (Wt) of the releasing agent in the toner satisfy the following relationships:
0.01≦Ws/Wt≦0.05 Relationship 4
0.05≦Ws≦0.20 Relationship 5
4≦Wt≦10 Relationship 6
wherein the total amount (Wt) is a weight conversion value converted from an endothermic absorption amount of the releasing agent in the toner obtained by a differential scanning thermometer (DSC) and the surface amount (Ws) is a value obtained from an intensity ratio (P2,850/P828) of the peak value (2,850 cm⁻¹) of the releasing agent to the peak value (828 cm⁻¹) of the binder resin.

3. The method of manufacturing toner according to claim 1, wherein the releasing agent is selected from the group consisting of carnauba wax which is subject to a treatment of eliminating free aliphatic acid therefrom, rice wax, montan wax, ester wax and a combination thereof.

4. The method of manufacturing toner according to claim 1, wherein a weight ratio of the oil phase to the aqueous phase is from 0.25 to 1.5.

5. The method of manufacturing toner according to claim 1, wherein the binder resin comprises a polyester resin.

6. The method of manufacturing toner according to claim 1, wherein the oil phase further comprises a compound having an active hydrogen group and a polymer having a portion reactive with the compound, and further comprising granulating the oil phase particles by reacting the compound with the polymer.

7. The method of manufacturing toner according to claim 1, wherein a ratio (Dv/Dn) of the volume average particle diameter (Dv) of the oil phase particles in the tank to a number average particle diameter (Dn) thereof is not greater than 1.20.

8. A toner manufactured by a method comprising:
adding an oil phase comprising an organic solvent in which a binder resin, a coloring agent and a releasing agent are dissolved or dispersed and an aqueous phase to an emulsification device equipped with a stirrer,
continuously dispersing or emulsifying the oil phase and the aqueous phase in the emulsification device equipped with a stirrer to form a liquid dispersion or emulsion comprising oil phase particles;
transporting the liquid dispersion or emulsion to a tank;
removing the organic solvent from the liquid dispersion or emulsion followed by drying to form mother toner particles,
wherein the releasing agent has been preliminarily prepared to have a dispersion diameter of from 0.15 to 0.7 μm before the releasing agent is contained in the oil phase, a circumferential speed of the stirrer is from 15 to 25 m/s, and a volume particle diameter (DV′) of the oil phase particles at an exit of the emulsification device to the tank and a volume average particle diameter (Dv) of the oil phase particles in the tank satisfy the following relationships:
3.0≦DV′≦6.0 Relationship 1
4.0≦Dv≦7.5 Relationship 2
1.0≦Dv−Dv′<3.0 Relationship 3.

9. The toner manufactured by a method according to claim 8, wherein the binder resin has a characteristic peak at least at a wave number of 828 cm⁻¹ and the releasing agent has a wave number of 2,850 cm⁻¹ in an infrared spectrum obtained by a Fourier transform infrared-attenuated total reflectance (FTIR-ATR) method and a surface amount (Ws) of the releasing agent located on or near a surface of the toner and a total amount (Wt) of the releasing agent in the toner satisfy the following relationships:
0.01≦Ws/Wt≦0.05 Relationship 4
0.05≦Ws≦0.20 Relationship 5
4≦Wt≦10 Relationship 6
wherein the total amount (Wt) is a weight conversion value converted from an endothermic absorption amount of the releasing agent in the toner obtained by a differential scanning thermometer (DSC) and the surface amount (Ws) is a value obtained from an intensity ratio (P2,850/P828) of the peak value (2,850 cm⁻¹) of the releasing agent to the peak value (828 cm⁻¹) of the binder resin.
